(19) United States
(12) Patent Application Publication
(10) Pub. No.: US 2008/0052699 A1
(43) Pub. Date: Feb. 28, 2008

(54) Syncronized dual-processor firmware updates

(76) Inventors: Steven T. Baker, Salt Lake City, UT (US); Douglas J. Kogan, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/497,747

(22) Filed: Aug. 2, 2006

(51) Int. Cl. G06F 9/44

(52) U.S. Cl. 717/168

(57) ABSTRACT

A method for synchronized dual-processor firmware updates. In one example embodiment, a method includes receiving a combined firmware update file, verifying the source of the combined firmware update file, extracting a master firmware image and a slave firmware image from the combined firmware update file, verifying the data integrity of the master firmware image, sending the slave firmware image to the slave processor, receiving a signal from the slave processor indicating that the slave firmware image has been installed, and installing the master firmware image. In another embodiment, a method includes receiving a slave firmware image from the master processor, verifying the data integrity of the slave firmware image, installing the slave firmware image, and sending a signal to the master processor indicating that the slave firmware image has been installed.

### BACKGROUND

Computers and computing systems have affected nearly every aspect of modern living. Computers are generally involved in work, recreation, healthcare, transportation, entertainment, household management, etc. As computers become more widely used, digital data also becomes more prevalent and more desirable. For example, digital data can be used to represent audio and video signals. Music on CDs is stored digitally. Audio and video on DVDs is also stored digitally. Television signals provided over cable and satellite systems is generally provided in a digital format. In many areas, digitally encoded television signals can even be received from traditional over the air (OTA) broadcasters that have previously only broadcast analog signals.

Because this data can be stored digitally, individuals have begun using media servers where audio, video, and image data is stored on a computer system, central server or other central storage. This allows the user to have a repository of multimedia data. The user can then play or display the multimedia data directly from the computer, or send the data over the network to another computer or media player through a network connection.

Some media players have dual processors. For example, a media player may have one processor dedicated primarily to network functions and another processor dedicated primarily to decoder functions. The respectively functionalities of processors in dual-processor media players are typically interdependent.

In some dual-processor media players, each processor has its own independent memory component which contains its firmware image. Since the respective functionalities provided by each processor are interdependent, when an upgrade to one firmware image becomes necessary, in most cases both firmware images must be upgraded at the same time to ensure proper operation of the dual processors. Manually updating both firmware images at the same time, however, can be complicated and error prone.

The subject matter claimed herein is not limited to embodiments that solve any disadvantages or that operate only in environments such as those described above. Rather, this background is only provided to disclose one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention may include methods for synchronized dual-processor firmware updates. Current embodiments provide the ability for firmware images to be updated on a master processor and a slave processor in a synchronized fashion. For example, in one embodiment a method includes receiving a combined firmware update file, verifying the source of the combined firmware update file, extracting a master firmware image and a slave firmware image from the combined firmware update file, verifying the data integrity of the master firmware image, sending the slave firmware image to the slave processor, receiving a signal from the slave processor indicating that the slave firmware image has been installed, and installing the master firmware image. In another embodiment a method includes receiving a slave firmware image from the master processor, verifying the data integrity of the slave firmware image, installing the slave firmware image, and sending a signal to the master processor indicating that the slave firmware image has been installed.

Embodiments of the present invention may also include a combined firmware update file. Current embodiments of the combined firmware update file facilitate the updating of firmware images of dual processors of a dual-processor device in a synchronized fashion provide. For example, in one embodiment a combined firmware update file includes a virtual first data structure, a virtual second data structure, and a virtual third data structure. The virtual first data structure includes a first firmware image field configured to contain a first firmware image corresponding to a first processor. The virtual second data structure includes a second firmware image field configured to contain a second firmware image corresponding to a second processor. The virtual third data structure includes a security signature field configured which enables the source of the first data structure and the second data structure to be securely verified.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are disclosed in the appended drawings. Understanding that these drawings depict only typical embodiments and are not therefore to be considered to be limiting in scope, embodiments will be described and explained with additional specificity and detail through the use of the accompanying drawings in which:

FIG. 1 discloses an overview of an example system for delivering media content to users;

FIG. 2 discloses a block-diagram of an example media player;

FIG. 3 discloses an example combination firmware update file; and

FIG. 4 discloses an example method for synchronized dual processor firmware updates.

### DETAILED DESCRIPTION OF EXAMPLE EMBODIMENTS

As noted above, example embodiments of the invention relate to methods for synchronized dual-processor firmware updates as well as a combined firmware update file. Among other things, the example methods and structures disclosed herein provide for secure and reliable automatic updates to firmware images of a dual-processor device in a synchronized fashion.

### I. Example System for Delivering Media Content to Users

The example methods disclosed herein can be implemented in a dual processor system, where the dual processors are interconnected via an interface intended for connection to storage devices such as an IDE interface. IDE interfaces are typically used for storage communication as opposed to processor interconnection. A system may include a specialized media CODEC or decoder processor which includes specialized hardware for decoding and displaying media data, such as audio, video and/or image data. The decoder processor may be connected via an IDE interface, or other storage-based connection, to a network processor that includes functionality for sending and receiving data across a network. By connecting the network processor to the decoder processor through an IDE interface, the network processor can be treated by the decoder processor as an IDE storage device. An emulator can be used to convert storage operations to network and communication operations and vice versa.

The network processor includes an interface for connecting to a network where data can be obtained. For example, the network processor may connect to a server which includes physical storage for storing data. To obtain video or other data, the video decoder processor may send storage device protocol messages across the IDE interface and to the network processor. This is done in a transparent fashion such that the decoder processor treats the network processor as a storage device. The network processor can then obtain data from a server across a network and provide the data to the decoder processor in a fashion similar to how a storage device provides data across an IDE interface. Because data is being obtained by the network processor across a network, network delays may be introduced into the architecture.

Typically, when implementing an IDE interface, it is assumed that the storage device is local to the processor accessing the storage device and that communications take place fairly quickly. However, the network delays described above may result in various difficulties. For example, one particular method of accessing data across an IDE interface involves sending an IDE request. To avoid corruption of data and other difficulties, only a single IDE request should be active at any particular time. When a physical storage device is in near proximity to the processor consuming data from the storage device, there is usually little difficulty due to the speed of the connection between the processor and storage device. Specifically, by the time a following IDE request is made, a previous IDE request will always be completed. However, when network delays are introduced, there may be some difficulty in that longer than expected latencies may exist between the time when an IDE request is issued and when the corresponding data is returned. To counteract these timing difficulties, inter-processor techniques herein described can be used in recovering the system.

An additional difficulty not expected by IDE storage busses relates to conditions when no responses are received. When a processor is connected to an IDE device over a network, loss of network connectivity or loss of network devices or services may result in a condition where there is no response whatsoever from an IDE request. For example, if a network service is instantiated and later shut-down, an IDE request may be issued for retrieving data from the network service where no response will be received because the service is not able to send a response of any kind.

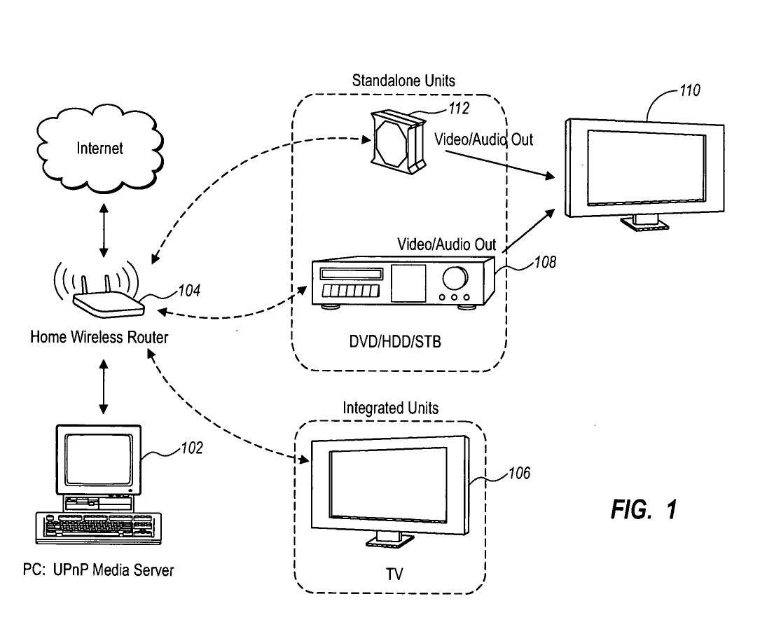

Referring now to FIG. 1, an exemplary environment where some embodiments of the invention may be practiced is disclosed. FIG. 1 discloses a media server 102, which in this example is a universal plug and play (UPnP) server. The media server 102 may store various media files such as music files, video files, and picture files. Generally, the media server 102 is located in a local area network (LAN) and is configured to provide the media files locally to clients. For example, in one embodiment, the media server 102 may be implemented in a home environment to provide media to home users.

In the illustrated embodiment, the media server 102 is connected through a router 104 to various clients in the network. The clients on the network may include specialized media adapters configured to provide media to users. As will be discussed further, the media adapters may include specialized hardware optimized for providing the media to users. For example, the media adapters may include processors that are optimized for decoding compressed audio, video or image data. The media adaptors may be embodied in a number of forms. For example, FIG. 1 disclosed media adapter integrated into a television 106.

FIG. 1 also discloses a number of standalone units. For example, the media adapter may be integrated into a DVD player 108. This embodiment is particularly interesting because the encoding on DVDs is the same as the encoding for stored video files or over the air (OTA) transport streams. Thus, the specialized hardware can be used both for decoding DVD signals as well as decoding data streamed from the media server 102 to the media adapter in the DVD player 108. The DVD player 108 is connected through audio and video connections to a television 110 where the DVD video can be played or where the media data from the media server 102 can be displayed.

FIG. 1 further discloses a self contained media adapter 112. The self contained media adapter 112 includes the specialized hardware for decoding and displaying media streamed from the media server 102. The self contained media adapter 112 is connected to the television 110 through audio and video connections.

Each of the media adapters, whether embodied as an integrated unit or as a standalone unit, is connected, in this example, through the router 104 to the media server 102. The connections between the media server 102, router 104 and media adapters may be any suitable network connection including hardwired Ethernet connections, wireless WiFi connections, or any other suitable connection. Notably, some embodiments described herein optimize wireless network connections to maintain suitability for transmitting high bit rate media files.

### II. Example Media Player

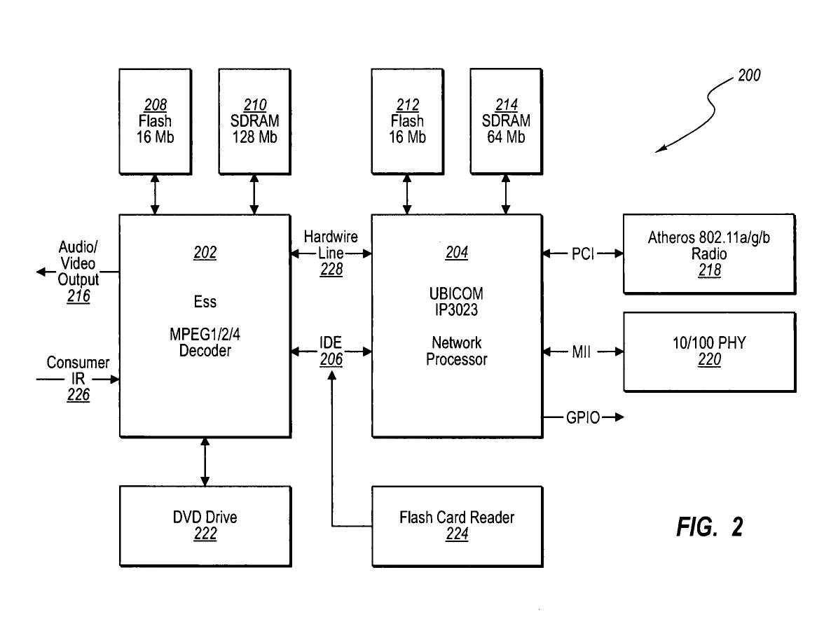

Referring now to FIG. 2, one example of the hardware used to implement a media adapter, designated generally at 200, is disclosed. As described previously, in the illustrated embodiment the media adapter 200 includes two processors that are coupled by an IDE bus. While an IDE bus is disclosed here, other storage device type busses may also be used. The media adapter 200 includes an mpeg decoder processor 202 coupled to a network processor 204 through an IDE bus 206. Each of the processors 202, 204 includes other appropriate peripheral hardware depending on the needs of a particular application. For example, in one embodiment the decoder processor 202 is coupled to flash memory 208 and DRAM memory 210. The flash memory and DRAM memory 210 may store computer executable instructions such as computer applications to be executed on the decoder processor 202. For example, the flash memory 208 may store a firmware image corresponding to the decoder processor 202. Additionally, the DRAM memory 210 may store data from the network processor 204, such as audio, video, or image data. The data stored in the DRAM memory 210 can be displayed by sending audio and video signals through the audio video output line 216. Notably, the audio video output line 216 may be any one of a number of formats including various combinations of composite, component video, HDMI, DVI, and the like.

Similar to the decoder processor 202, the illustrated network processor 204 has a flash memory 212 and a DRAM memory 214 connected to it. The flash memory 212 and DRAM memory 214 are computer readable media that may include computer executable instructions that can be executed by the network processor 204. For example, the flash memory 212 may store a firmware image corresponding to the network processor 204. In addition, the DRAM memory 214 may store data for delivery to the decoder processor 202. For example, the network processor 204 may receive data from a data store such as the media server 102. This data may be stored in the DRAM memory 214 for delivery to the decoder processor 202. Such data may include for example, media, file information, directory information, or other information. In this example, the network processor 204 may be connected to a media server through one or more different network connections.

FIG. 2 discloses both wired and wireless connections. For example, the network processor may be connected through a PCI bus connection to a wireless radio 218. In this example, the wireless radio 218 supports IEEE 802.11a, b, and g wireless signals. IEEE 802.11a and g may be advantageous for video transmission as they are able to handle media streams at higher bit rates than IEEE 802.11b transmissions. The wireless radio 218 may communicate with a wireless router, such as the router 104 shown in FIG. 1. The wireless router 104 can then communicate with the media server 102, either wired or wirelessly, for completing the connection between the network processor 204 and the media server 102.

FIG. 2 further discloses that the network processor 204 may communicate with the media server through a wired connection such as by using a standard 10/100 Mbs (megabits per second) Ethernet adapter, denoted at 220. Similar to the wireless example, the Ethernet adapter 220 may be connected to the router 104, which is in turn connected to the media server 102. While in this example a 10/100 Mbs adapter is used, it should be appreciated that Gigabit Ethernet adapters, or any other suitable adapter, whether wired or wireless, may be used.

FIG. 2 discloses two additional options. The first is a DVD drive 222 connected to the decoder processor 202. As explained previously, often the encoding on DVDs is the same as the encoding for other video and audio files. As such, the specialized hardware on the decoder processor 202 is especially suited for decoding DVD video. As such, a more functional device may be implemented where the device includes a DVD drive 222 such that DVD video can be played from the device. Such a device is disclosed in FIG. 1 at 108.

FIG. 2 discloses a second option, which includes a flash card reader 224 connected to the decoder processor 202 through the IDE bus 206. This option allows users to display media from a portable flash card using the media adapter 200. For example, flash cards from digital cameras or camcorders can be plugged directly into the flash card reader 224 obviating the need to store the media on the media server 102 prior to viewing the media using the media adapter 200. One or more alternatives for the flash card reader 224 may be provided. For example, the flash card reader 224 may have provisions for compact flash, secure digital, multimedia, etc. Additionally, in one embodiment, the flash card reader 224 may include a USB interface for connecting directly to a USB flash storage device or USB connectable hard-disk drive.

Again, in the illustrated example the two processors, the decoder processor 202 and network processor 204, are connected through an IDE bus 206. Ordinarily such communications would take place on a PCI or other type of communication bus. Typically, an IDE bus is used for connecting storage to a processor. However, by using an IDE bus 206 to connect to the decoder processor 202 and network processor 204, several advantages can be realized. For example, typical decoder processors come equipped with a standard IDE bus interface for connecting storage to the decoder processor. However, some decoder processors may not come equipped with network connectivity, and as such may not be suitable on their own for use in a media adapter connectable in a network. By using the IDE bus interface (or similar storage connection-oriented bus interface) to connect through an IDE bus to a network processor, networking functionality can be added to virtually any media decoder processor.

This type of configuration allows for a number of other advantages as well, including: the ability to use a smaller operating system, easier selection of a specialized network processor, easy replacement of the network processor in subsequent designs when additional networking speeds and functionality become available, easy replacement of the decoder processor in subsequent designs, reduced memory requirements, etc.

Ordinarily, a storage device connected to a host processor through an IDE bus is somewhat passive in nature. In other words, an IDE device typically accepts commands from the host processor, and can be polled by the host processor for information, but does not usually provide data to the host processor without first being prompted. In the example shown in FIG. 2, the decoder processor 202 assumes the role of the host processor and the network processor 204 assumes the role of the device in the IDE connection. To facilitate the network processor 204 providing information to the decoder processor 202, in the example embodiment a hardware line 228 connects the two processors. If the network processor 204 has information to pass to the decoder processor 202, the network processor 204 can set the line signaling to the decoder processor 202 that the network processor 204 has information to pass to the decoder processor 202. The decoder processor 202 can then detect the assertion of the hardware line from the network processor 204 and read the information from the network processor 204. Such information may include, among other things, diagnostic information.

For example, the network processor 204 may be able to detect various conditions such as a storage device not being connected to one of the network connections 218, 220, or the inoperability of the network. The network processor 204 can thus signal on the hardware line 228 that it has data for the decoder processor. When the decoder processor 202 detects the assertion of the hardware line from the network processor 204, the decoder processor 202 can read the diagnostic information from the network processor 204.

In the illustrated example, the particular decoder processor 202 shown is an MPEG1/2/4 decoder, which may be implemented using part numbers ES6425FF, ES8381FCD, or ES6430FAA available from ESS Technology, Inc. located in Fremont Calif. While any one of a number of different devices/implementations could be used, these particular decoders include various hardware components including a central processing unit, a DMA state machine, an interrupt state machine and a media player state machine. The central processing unit coordinates interactions between the different state machines and generally manages data flow and decoding activities. The DMA state machine manages DMA data requests to perform DMA data handling. The interrupt state machine generally includes a number of registers and indicators indicating active interrupts for obtaining service from the central processing unit from other components including components included in the decoder processor 202. The media player state machine includes functionality for controlling how media is accessed and played for a user. For example, the media player state machine may include functionality for implementing play, pause, fast-forward, rewind, etc. This can be used to control what data is requested, and when the data is requested.

### III. Example Combination Firmware Update File

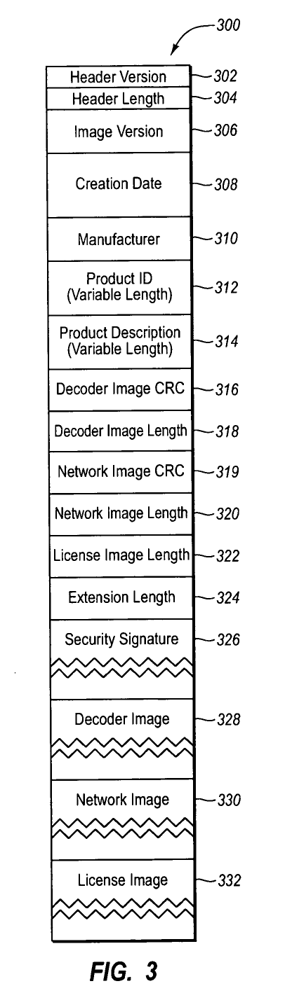

Systems having dual processors, such as the media adapter 200 of FIG. 2, may require that the firmware image associated with each processor be upgraded or updated at the same time in order to ensure proper operation of the dual processors. Turning now to FIG. 3, aspects of an example combination firmware update (CFU) file 300 are disclosed. The CFU file 300 can be used in a dual-processor system or device, such as the media adapter 200 of FIG. 2, to enable the firmware images of the dual processors to be updated in a secure and synchronized fashion.

The CFU file 300 includes a set of virtual data structures including a plurality of data fields that facilitate the updating of firmware images of dual processors of a dual-processor device in a synchronized fashion. The CFU file 300 includes a header version field 302, a header length field 304, an image version field 306, a creation date field 308, a manufacturer field 310, a product identifier field 312, a product description field 314, a decoder image CRC field 316, a decoder image length field 318, a network image CRC 319, a network image length field 320, a license image length field 322, an extension length field 324, a security signature field 326, a decoder image field 328, a network image field 330, and a license image field 332. The fields 302-326 make up a header portion 334 of the CFU file 300. In one embodiment, all field values included in the header portion 334 of the CFU file 300 are written in big-endian format.

The header version field 302 is a 16-bit value used to represent major and minor version numbers of the header portion 334 of the CFU file 300. The first (hi) byte is allocated for the major version number, and the low byte is for the minor version number. For example the version “2.11” would be expressed as “0x020b”. The major format version number is only changed when a non-backward compatible change is made.

The header length field 304 is a 16-bit field that specifies the total length of the header portion 334 of the CFU file 300. This field is included to permit expansion of the header portion 334 with backward compatibility. Older header processors can safely skip any additional, unrecognized fields.

The image version field 306 is a 32-bit field that specifies the version assigned to the CFU file 300. The image version field 306 is machine readable so that a dual-processor device can reliably compare existing and available firmware versions. One example format for the image version field 306 is the decimal format “YYMMDDBB”. For example, the version “05010100” represents “Jan. 1, 2005, build 0”.

The creation date field 308 is a 6-byte field that represents the creation date and time for the CFU file 300. The date is expressed in the following series of 8-bit values: day, month, year (since 2000), hour minute, second.

The manufacturer field 310 is a 4-byte field that uniquely identifies the original equipment manufacturer (OEM) providing the firmware images contained in fields 328 and 330. This value is a self-assigned string (e.g. “KEST”) and can be used to identify which security key to use when calculating an MD5 hash on the header portion 334, as disclosed in greater detail below. It can also be used to verify the firmware manufacturer with hardware and/or software before updating firmware images on a device. The identifier value stored in the manufacturer field 310 can be between 1 and 4 bytes long.

The product identifier field 312 is a variable length field that uniquely identifies the model of the device for which the firmware images contained in fields 328 and 330 are intended. The product identifier field 312 is a self-assigned machine readable string (e.g. “1X4093-U”).

The product description field 314 is a human readable, variable length string that identifies the firmware images contained in fields 328 and 330 to the user. For example, this string can include the manufacturer name, model name and firmware version (e.g. “Kestrelink KM98560 version 05010100”).

The decoder image CRC field 316 is a field that contains a cyclical redundancy check (CRC) checksum corresponding to the firmware image contained in the decoder image field 328. The integrity of the firmware image contained in the decoder image field 328 is protected with an external CRC. The resulting checksum of the CRC is stored in the decoder image CRC field 316. A recipient processor, such as the decoder processor 202, can verify this CRC checksum before installing the firmware image contained in the decoder image field 328.

The decoder image length field 318 is a 32-bit field used to identify the end of the decoder image field 328 and to verify the size of the firmware image contained in the decoder image field 328. The network image length field 320 is a 32-bit field used to verify the end of the network image field 330 and to verify the size of the firmware image contained in the network image field 330. The license image length field 322 is a 32-bit field used to verify the end of the license image field 332 and to verify the size of the firmware image contained in the license image field 332. The value of each of fields 318-320 can be zero if no image is contained in its corresponding image field.

The network image CRC field 319 is a field that contains a cyclical redundancy check (CRC) checksum corresponding to the firmware image contained in the network image field 330. The integrity of the firmware image contained in the network image field 330 is protected with an external CRC. The resulting checksum of the CRC is stored in the network image CRC field 319. A recipient processor, such as the network processor 204, can verify this CRC checksum before installing the firmware image contained in the network image field 330.

The extension length field 324 is a 32-bit field used to verify the end of any extension area (not shown) concatenated to the end of the CFU file 300. This value can be zero if no extension area is concatenated to the end of the CFU file 300.

The security signature field 326 is an MD5 hash based on the header portion 334 or some subset of the header portion 334. The value of the security signature field 326 is calculated by running the MD-5 algorithm over the header portion 334 or some subset of the header portion 334. The security signature field 326 also includes a manufacturer key that is a 128 bit universally unique identifier (UUID). This can be assigned by the manufacturer identified in the manufacturer field 310 or another party.

The decoder image field 328 contains the raw decoder ROM firmware image. The network image field 330 contains the raw network ROM firmware image. The license image field 332 contains the license image.

### IV. Example Method for Synchronized Dual Processor Firmware Updates

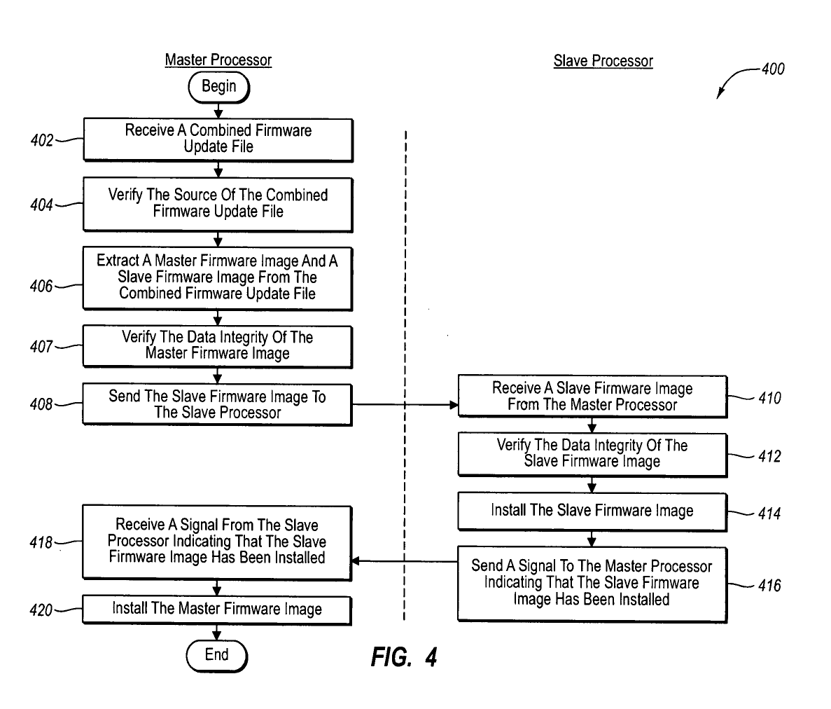

With continued reference to FIGS. 1, 2, and 3, and now also with reference to FIG. 4, an example method for synchronized dual processor firmware updates is disclosed by way of a series of process steps designated at 400. The method 400 of FIG. 4 can be implemented in a computing environment similar to FIGS. 1 and 2. More particularly, the method 400 can be implemented in a dual-processor computing environment where the dual processors are connected by a storage device type bus or busses, such as an IDE bus. The method 400 can also be implemented in a dual-processor computing environment where the dual processors are connected by a non-storage device type bus or busses. The method 400 is particularly suited to implementation where one processor functions as a master processor and the other processor functions as a slave processor.

For example, the method 400 can be implemented in the media adapter 200 of FIG. 2, with the decoder processor 202 functioning as the slave processor and the network processor 204 functioning as the master processor. As disclosed in FIG. 2, the decoder processor 202 and the network processor 204 can communicate data over the IDE bus 206. In addition, the network processor 204 and the decoder processor 202 can communicate controls signals over the hardware line 228.

In the disclosure of the method 400 below, various examples of each of the acts of the method 400 will be given. It is assumed for the purpose of these examples that the processors 202 and 204 of FIG. 2 are in communication with one or more computer-readable media which carry computer-executable instructions which enable the processors 202 and 204 to perform each of the acts disclosed in connection with the method 400.

Method 400 includes an act 402 of receiving a combined firmware update file. For example, the decoder processor 202 can receive a CFU file 300. The CFU file 300 can be received over a wired or wireless network connection. For example the CFU file 300 can be received over the wireless radio 218 or the Ethernet adapter 220.

The CFU file 300 can be received from a UPnP media server, such as media server 102, as part of a firmware update service. The media adapter 200 can, for example, check for an updated CFU file 300 or an expired timer on the media server 102 each time that the media server is initialized. Alternatively, the media server 102 can notify the media adapter 200 each time that an updated CFU file 300 is available for download from the media server 102.

In either case, a user of the media adapter 200 can be prompted to either allow the update of the firmware of the media adapter 200 to proceed immediately, or set a timer to prompt the user at some future time for permission to allow the update of the firmware on the media adapter 200. Alternatively, the user can be notified that the update of the firmware of the media adapter 200 is taking place. A third alternative provides for the update of the firmware of the media adapter 200 without prompting the user for permission or notifying the user of the update. The second and third alternatives can be useful for test and manufacturing of the media adapter 200.

Alternatively, the combined firmware update file can be received from the slave processor, who obtained the combined firmware update file from a CD or a DVD. For example, the decoder processor 202 may read the CFU file 300 from a CD or a DVD that has been placed in the DVD 222 drive. The decoder processor 202 can then transfer the CFU file 300 to the network processor 204 over the IDE bus 206.

Method 400 also includes an act 404 of verifying the source of the combined firmware update file. For example, the network processor 204 can verify that the CFU file 300 is from a legitimate provider of firmware updates for the media adapter 200. This verification can include using a MD5 hash contained within the combined firmware update file to verify the source of the combined firmware update. For example, the MD5 hash can be computed and verified with a shared key stored in the CFU file 300 and in the flash memory 212. The shared key can be based on a customer specific manufacturing identifier and guarantees that only the firmware for the network processor 204 will be accepted and updated on the network processor 204. For example, the network processor 204 can access the security signature field 326 of the CFU file 300 in order to use the MD5 hash contained therein to verify the source of the CFU file 300. The network processor 204 can further verify the version of the combined firmware update file. For example, the network processor 204 can check the data contained in the image version field 306 of the CFU file 300 to determine if the CFU file is the correct version.

Method 400 also includes an act 406 of extracting a master firmware image and a slave firmware image from the combined firmware update file. For example, the network processor 204 can extract the network ROM firmware image from the network image field 330 and the decoder ROM firmware image from the decoder image field 328 of the CFU file 300. The decoder image length field 318 and the network image length field 320 can be used to determine exactly how much data to extract from the CFU file 300 for each firmware image. At the same time that the slave firmware image is being extracted, which is the decoder ROM firmware image in this example, the network processor 204 can also extract the data contained in the decoder image CRC field 316 to later send to the decoder processor 202.

Method 400 also includes an act 407 of verifying the data integrity of the master firmware image. For example, the network processor 204 can verify the data integrity of the network ROM firmware image that was extracted from the network image field 330 of the CFU file 300. This verification can include using a cyclical redundancy check checksum to verify the data integrity of the master firmware image. For example, the network processor 204 can verify the data integrity of the network ROM firmware image using a checksum from the network image CRC field 319 of the CFU file 300.

Method 400 also includes an act 408 of sending the slave firmware image to the slave processor and an act 410 of receiving the slave firmware image from the master processor. For example, the network processor 204 can send, and the decoder processor 202 can receive, the decoder ROM firmware image from the decoder image field 328. The slave firmware image can be sent to, and received by, the slave processor over a storage device protocol. For example, the network processor 204 can send the decoder ROM firmware image to the decoder processor 202 over a protocol operating over the IDE bus 206. At the same time, the master processor can send, and the slave processor can receive, a cyclical redundancy check checksum corresponding to the slave firmware image. For example, the network processor 204 can send, and the decoder processor 202 can receive, the checksum contained in the decoder image CRC field 316 of the CFU file 300.

Method 400 also includes an act 412 of verifying the data integrity of the slave firmware image. For example, the decoder processor 202 can verify the data integrity of the decoder ROM firmware image received from the network processor 204. This verification can include using a cyclical redundancy check checksum to verify the data integrity of the slave firmware image. For example, the decoder processor 202 can verify the data integrity of the decoder ROM firmware image using the checksum from the decoder image CRC field 316 of the CFU file 300.

Method 400 also includes an act 414 of installing the slave firmware image. For example, the decoder processor 202 can install the decoder ROM firmware image. This installation can include overwriting a current firmware image corresponding to the slave processor with the slave firmware image. For example, the decoder processor 202 can overwrite a current firmware image corresponding to the decoder processor 202 with the decoder ROM firmware image received from the network processor 204. The firmware image corresponding to the decoder processor 202 can be stored, for example, in the flash memory 208.

Method 400 also includes an act 416 of sending a signal to the master processor indicating that the slave firmware image has been installed and an act 418 of receiving a signal from the slave processor indicating that the slave firmware image has been installed. For example, the decoder processor 202 can send, and the network processor 204 can receive, a signal indicating that the decoder ROM firmware image has been installed. This signal can be sent and received, for example, over the IDE bus 206 or the hardware line 228.

Method 400 also includes an act 420 of installing the master firmware image. For example, the network processor 204 can install the network ROM firmware image. This installation can include overwriting a current firmware image corresponding to the master processor with the master firmware image. For example, the network processor 204 can overwrite a current firmware image corresponding to the network processor 204 with the network ROM firmware image extracted from the network image field 330 of the CFU file 300. The firmware image corresponding to the network processor 204 can be stored, for example, in the flash memory 212.

The method 400 can further include an act of recording each act of the method 400 as it is completed and an act of performing any uncompleted acts of the method 400 upon initialization of the master processor and/or the slave processor. For example, the network processor 204 and/or the decoder processor 202 might loose power during the performance of any of the acts 402-420, thus leaving one or more of the acts 402-420 uncompleted. Where each of the completed acts are recorded, when the network processor 204 or the decoder processor 202 is once again brought online, the processor can determine which acts of method 400 remain to be completed and complete those acts before performing other functions. This error handling functionality enables secure and reliable dual-processor synchronized firmware updates even where the method 400 is unexpectedly interrupted.

The method 400 can further include acts for license image distribution. The method 400 can alternatively include acts for updating only a license image, only a first firmware image, or only a second firmware image. For example, license images are commonly used to license devices during the manufacturing and testing or the devices.

The example CFU file 300 of FIG. 3 and the example method 400 of FIG. 4 can be implemented using computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment including a master processor and a slave processor, a method for synchronized updating, at the master processor, of the master processor firmware image and the slave processor firmware image using a combined firmware update file, the method comprising the acts of:
receiving a combined firmware update file;
verifying the source of the combined firmware update file;
extracting a master firmware image and a slave firmware image from the combined firmware update file;
verifying the data integrity of the master firmware image;
sending the slave firmware image to the slave processor;
receiving a signal from the slave processor indicating that the slave firmware image has been installed; and
installing the master firmware image.

2. The method as recited in claim 1, wherein receiving a combined firmware update file comprises receiving the combined firmware update file over a wired or wireless network connection.

3. The method as recited in claim 1, wherein receiving a combined firmware update file comprises receiving the combined firmware update file from the slave processor who obtained the combined firmware update file from a CD or a DVD.

4. The method as recited in claim 1, wherein verifying the source of the combined firmware update file at the master processor comprises using a MD5 hash contained within the combined firmware update file to verify the source of the combined firmware update file.

5. The method as recited in claim 1, wherein verifying the data integrity of the master firmware image comprises using a cyclical redundancy check checksum extracted from the combined firmware update file to verify the data integrity of the master firmware image.

6. The method as recited in claim 1, wherein sending the slave firmware image to the slave processor comprises sending the slave firmware image to the slave processor over a storage device protocol.

7. The method as recited in claim 1, wherein installing the master firmware image comprises overwriting a current firmware image corresponding to the master processor with the master firmware image.

8. The method as recited in claim 1, further comprising the act of verifying the version of the combined firmware update file.

9. The method as recited in claim 1, further comprising the acts of:
recording each act of the method as it is completed; and
performing any uncompleted acts of the method upon initialization of the master processor.

10. In a computing environment including a master processor and a slave processor, a method for synchronized updating, at the slave processor, of the master processor firmware image and the slave processor firmware image using a combined firmware update file, the method comprising the acts of:
receiving a slave firmware image from the master processor;
verifying the data integrity of the slave firmware image;
installing the slave firmware image; and
sending a signal to the master processor indicating that the slave firmware image has been installed.

11. The method as recited in claim 10, further comprising the act of reading the combined firmware update file from a CD/DVD and sending the combined firmware update file to the master processor, prior to receiving a slave firmware image from the master processor.

12. The method as recited in claim 10, wherein receiving a slave firmware image from the master processor further comprises receiving a cyclical redundancy check checksum corresponding to the slave firmware image from the master processor.

13. The method as recited in claim 12, wherein verifying the data integrity of the slave firmware image comprises using the cyclical redundancy check checksum to verify the data integrity of the slave firmware image.

14. The method as recited in claim 10, wherein receiving a slave firmware image from the master processor comprises receiving a slave firmware image from the master processor over a storage device protocol.

15. The method as recited in claim 10, wherein installing the slave firmware image comprises overwriting a current firmware image corresponding to the slave processor with the slave firmware image.

16. The method as recited in claim 10, further comprising the act of locking a memory corresponding to the slave processor prior to verifying the data integrity of the slave firmware image.

17. The method as recited in claim 10, further comprising the acts of:
recording each act of the method as it is completed; and
performing any uncompleted acts of the method upon initialization of the slave processor.

18. In a computing environment, one or more computer readable media including a plurality of data fields that make up a combined firmware update file that facilitates the updating of firmware images of dual processors in a dual-processor device in a synchronized fashion, the computer readable media comprising:
a virtual first data structure, the virtual first data structure comprising a first firmware image field configured to contain a first firmware image corresponding to a first processor;
a virtual second data structure, the virtual second data structure comprising a second firmware image field configured to contain a second firmware image corresponding to a second processor; and
a virtual third data structure, the virtual third data structure comprising a security signature field configured which enables the source of the first data structure and the second data structure to be securely verified.

19. The computer readable media as recited in claim 18, wherein the computer readable media further comprises:
a virtual fourth data structure, the virtual fourth data structure comprising a cyclical redundancy check field configured to contain a cyclical redundancy check checksum which enables the data integrity of at least one of the first or second firmware images to be verified.

20. The computer readable media as recited in claim 18, wherein the computer readable media further comprises:
a virtual fifth data structure, the virtual fifth data structure comprising at least one of the following:
a header version field configured to contain a format of the combined firmware update file;
a header length field configured to contain a total header length of the combined firmware update file;
an image version field configured to contain a version assigned to the combined firmware update file;
a creation date field configured to contain a date and time the combined firmware update file was created;
a manufacturer field configured to contain an identifier of the original equipment manufacturer who provided the first and second firmware images;
a product identifier field configured to contain a model of the dual-processor device;
a product description field configured to contain a description of the first and second firmware images;
a first firmware image length field configured to contain a length of the first firmware image; or
a second firmware image length field configured to contain a length of the second firmware image.

21. The computer readable media as recited in claim 18, wherein the computer readable media further comprises:
a virtual fourth data structure, the virtual fourth data structure comprising a license image field configured to contain a license image; and
a virtual fifth data structure, the virtual fifth data structure comprising a license image length field configured to contain a length of the license image.
